(19) United States
(12) Patent Application Publication
(10) Pub. No.: US 2026/0331346 A1
(43) Pub. Date: Oct. 22, 2026

(54) SPIN INDUCTOR AND MANUFACTURING METHOD OF SPIN INDUCTOR DEVICE

(71) Applicant: TDK CORPORATION, Tokyo (JP)

(72) Inventors: Tomoyuki SASAKI, Tokyo (JP); Eiji SUZUKI, Tokyo (JP)

(73) Assignee: TDK CORPORATION, Tokyo (JP)

(21) Appl. No.: 18/860,986

(22) PCT Filed: Jul. 4, 2023
(86) PCT No.: PCT/JP2023/024790

§ 371 Date: Oct. 28, 2024

(51) Int. Cl. H01F 10/32; H01F 27/28

(52) U.S. Cl. CPC H01F 10/324; H01F 27/2804

(57) ABSTRACT

This spin inductor includes a substrate; an inductor layer which includes a wiring layer and a first ferromagnetic layer in contact with the wiring layer; and a release layer which is located between the substrate and the inductor layer.

### TECHNICAL FIELD

The present disclosure relates to a spin inductor and a manufacturing method of spin inductor device.

### BACKGROUND ART

An inductor, along with a resistor and a capacitor, is a major electronic component and is used in various electronic devices, A coil is an example of the inductor. There is a trade-off relationship between the size of the coil and the magnitude of the inductance, and it is difficult to achieve a large inductance with a small coil.

In recent years, attention has been focused on a new type of inductor that does not use coils. A new type of inductor that does not use coils is sometimes called an emergent inductor. For example, Patent Document 1, Non-Patent Document 1, and Non-Patent Document 2 disclose a new inductor that uses spin vibration (hereinafter, referred to as a spin inductor). Since the inductance magnitude of the spin inductor becomes larger as the element size becomes smaller, the inductor is attracting attention because both miniaturization and large inductance magnitude can be achieved.

### CITATION LIST

### Patent Document

### Patent Document 1

PCT International Publication No. WO 2022/181069

### Non-Patent Document

### Non-Patent Document 1

Yuta Yamane, Shunsuke Fukami, and Junichi Ieda, Physical Review Letters 128,147201 (202).

### Non-Patent Document 2

Yasufumi Arai and Jun'ichi Ieda, Journal of the Physical Society of Japan 92, 074705 (2023).

### SUMMARY OF INVENTION

### Technical Problem

The performance of the spin inductor that uses spin is influenced by the quality of the interface between the magnetic layer and the wiring layer. Since integrated circuits are formed with various elements, their surface smoothness is inferior to that of substrates without circuits. Therefore, the spin inductor formed directly on integrated circuits may not perform adequately. In addition, since the spin inductor is a very small element compared to the substrate, the cost of the substrate in the product cannot be ignored. Then, there is a demand to reduce the cost of the substrate in order to reduce the product cost.

The present disclosure has been made in view of the above circumstances and an object thereof is to provide a manufacturing method capable of manufacturing a high-performance spin inductor device at low cost and a spin inductor thereof.

### Solution to Problem

In order to solve the above problems, the present disclosure provides the following means.
(1) A spin inductor according to a first aspect includes: a substrate; an inductor layer; and a release layer. The inductor layer includes a wiring layer and a first ferromagnetic layer which is in contact with the wiring layer. The release layer is located between the substrate and the inductor layer.
(2) The spin inductor according to the above-described aspect may further include a first via wiring and a second via wiring. Each of the first via wiring and the second via wiring is connected to the inductor layer.
(3) In the spin inductor according to the above-described aspect, the release layer may be in contact with the first via wiring and the second via wiring.
(4) In the spin inductor according to the above-described aspect, the inductor layer may be located between the first via wiring and the second via wiring and the release layer.
(5) The spin inductor according to the above-described aspect may further include a first insulating layer. The first insulating layer is located between the inductor layer and the release layer.
(6) In the spin inductor according to the above-described aspect, the release layer may be made of graphene.
(7) In the spin inductor according to the above-described aspect, the release layer may be made of hydrogen injected silicon.
(8) A spin inductor according to a second aspect includes: an inductor layer which includes a wiring layer and a first ferromagnetic layer in contact with the wiring layer; and a release layer which is in contact with a first surface of the inductor layer or in contact with the first surface of the inductor layer with an intermediate layer interposed therebetween.
(9) A manufacturing method of spin inductor device according to a third aspect includes: forming a release layer on a substrate; forming an inductor layer including a wiring layer and a first ferromagnetic layer in contact with the wiring layer on or above the release layer; and releasing the substrate and the inductor layer through the release layer.
(10) The manufacturing method of spin inductor device according to the above-described aspect may further include electrically connecting the inductor layer released from the substrate to the integrated circuit.
(11) The manufacturing method of spin inductor device according to the above-described aspect may further include: connecting a first via wiring and a second via wiring to the inductor layer, wherein any one of the plurality of via wirings formed on the integrated circuit may be bonded to the first via wiring, and any one of the plurality of via wirings may be bonded to the second via wiring.
(12) In the manufacturing method of spin inductor device according to the above-described aspect, any one of the plurality of via wirings may be bonded to the first via wiring by solder, and any one of the plurality of via wirings may be bonded to the second via wiring by solder.

### BRIEF DESCRIPTION OF DRAWINGS

FIG. 1 is a cross-sectional view of a spin inductor device according to a first embodiment.

FIG. 2 is a plan view of the spin inductor according to the first embodiment.

FIG. 3 is a schematic view illustrating a function of the spin inductor according to the first embodiment.

FIG. 4 is a diagram illustrating a first example of a method of manufacturing the spin inductor device according to the first embodiment.

FIG. 5 is a diagram illustrating the first example of the method of manufacturing the spin inductor device according to the first embodiment.

FIG. 6 is a diagram illustrating the first example of the method of manufacturing the spin inductor device according to the first embodiment.

FIG. 7 is a diagram illustrating the first example of the method of manufacturing the spin inductor device according to the first embodiment.

FIG. 8 is a diagram illustrating the first example of the method of manufacturing the spin inductor device according to the first embodiment.

FIG. 9 is a diagram illustrating the first example of the method of manufacturing the spin inductor device according to the first embodiment.

FIG. 10 is a diagram illustrating the first example of the method of manufacturing the spin inductor device according to the first embodiment.

FIG. 11 is a diagram illustrating a second example of the method of manufacturing the spin inductor device according to the first embodiment.

FIG. 12 is a diagram illustrating the second example of the method of manufacturing the spin inductor device according to the first embodiment.

FIG. 13 is a diagram illustrating the second example of the method of manufacturing the spin inductor device according to the first embodiment.

FIG. 14 is a diagram illustrating the second example of the method of manufacturing the spin inductor device according to the first embodiment.

FIG. 15 is a diagram illustrating the second example of the method of manufacturing the spin inductor device according to the first embodiment.

FIG. 16 is a diagram illustrating the second example of the method of manufacturing the spin inductor device according to the first embodiment.

FIG. 17 is a cross-sectional view of a spin inductor according to a first modified example.

FIG. 18 is a cross-sectional view of a spin inductor according to a second modified example.

FIG. 19 is an application example of the spin inductor according to this embodiment.

### DESCRIPTION OF EMBODIMENTS

Hereinafter, this embodiment will be described in detail with reference to the drawings. The drawings used in the following description may show characteristic parts in an enlarged scale for the sake of convenience in order to make the characteristics easier to understand, and the dimensional ratios of each component may differ from the actual ones. The materials, dimensions, and the like exemplified in the following description are merely examples, and the present disclosure is not limited to them. They can be modified as appropriate within the scope of the effects of the present disclosure.

First, directions will be defined. A direction in which each layer extends is defined as the x direction, and a direction perpendicular to the x direction is defined as the y direction. For example, a first direction connecting a first via wiring 4 and a second via wiring along a wiring layer 2 is defined as the x direction. In the xy plane, a second direction perpendicular to the x direction is, for example, the y direction. Further, the thickness direction of each layer is defined as the z direction. The x and y directions are perpendicular to the z direction.

### First Embodiment

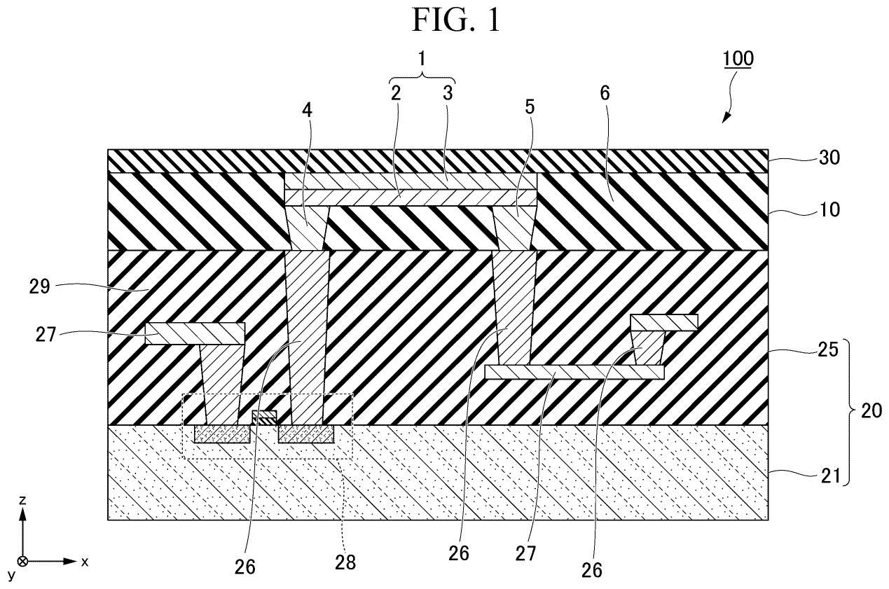

FIG. 1 is a cross-sectional view of a spin inductor device 100 according to a first embodiment. FIG. 1 is a cross-sectional view of the spin inductor device 100 cut along the xz plane passing through the center of the wiring layer 2 in the y direction.

The spin inductor device 100 is a device in which a spin inductor and an integrated circuit that controls the spin inductor are integrated together. The spin inductor device 100 includes, for example, a spin inductor 10, an integrated circuit 20, and a protective layer 30.

The integrated circuit 20 is a circuit in which a control element that controls the operation of the device is formed. The integrated circuit 20 includes, for example, a substrate 21 and a circuit layer 25.

The substrate 21 is, for example, a semiconductor substrate. The semiconductor substrate is, for example, a Si substrate, a SiC substrate, or a III-V group semiconductor substrate.

The circuit layer 25 includes, for example, a via wiring 26, an in-plane wiring 27, electronic components 28, and an insulating layer 29.

The via wiring 26 extends in the z direction and electrically connects different layers. The in-plane wiring 27 extends in any direction in the xy plane and electrically connects the same layer in the plane. Each of the via wiring 26 and the in-plane wiring 27 includes a conductor having excellent electrical conductivity. The via wiring 26 and the in-plane wiring 27 are made of, for example, Cu, Al, Ag, Au, or the like.

The electronic components 28 are elements that control the spin inductor 10. The electronic components 28 are, for example, transistors, capacitors, diodes, resistors, and the like. The insulating layer 29 is an insulating layer that provides insulation between wirings in a multilayer wiring structure and between elements. The insulating layer 29 can be made of a material similar to that used for insulating layers in semiconductor devices. The insulating layer 29 is made of, for example, silicon oxide (SiOₓ), silicon nitride (SiNₓ), silicon carbide (SiC), chromium nitride (CrN), silicon carbonitride (SiCN), silicon oxynitride (SiON), aluminum oxide (Al₂O₃), or zirconium oxide (ZrOₓ).

The protective layer 30 protects the spin inductor 10 from the outside. The protective layer 30 is, for example, an insulator. A known material can be used for the protective layer 30. The protective layer 30 is made of, for example, the same material as the insulating layer 29.

The spin inductor 10 is an inductor that operates by vibration of magnetization in a magnetic material. The spin inductor 10 cuts off the high frequency components of the current and passes the constant components of the current. The current flows between the first via wiring 4 and a second via wiring 5. The spin inductor 10 is disposed in a portion where it is desired to cut off high frequency current. High frequency current is cut by the spin inductor 10, but direct current flows through the spin inductor 10. For direct current, the spin inductor 10 is a resistor.

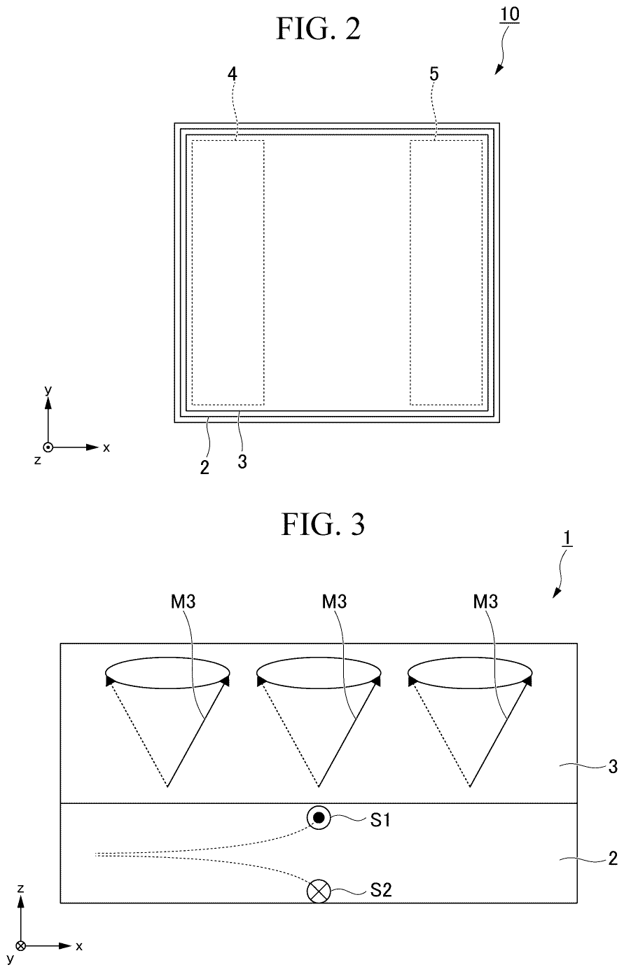

FIG. 2 is a plan view of the spin inductor 10. The spin inductor 10 includes, for example, an inductor layer 1, the first via wiring 4, and the second via wiring 5. The spin inductor 10 is covered with an insulating layer 6. The insulating layer 6 is made of the same material as the insulating layer 29.

The first via wiring 4 and the second via wiring 5 include a material having electrical conductivity. The first via wiring 4 and the second via wiring 5 are made of, for example, Cu, Al, Ag, Au, or the like. The first via wiring 4 is in contact with the wiring layer 2 of the inductor layer 1. The second via wiring 5 is in contact with the wiring layer 2 of the inductor layer 1 at a position different from the first via wiring 4. The first via wiring 4 and the second via wiring 5 extend in the z direction.

The spin inductor 10 may include a first terminal and a second terminal which are in contact with the side surface of the inductor layer 1 instead of the first via wiring 4 and the second via wiring 5. Further, each of the first via wiring 4 and the second via wiring 5 may be in contact with the upper surface of the inductor layer 1.

The inductor layer 1 includes the wiring layer 2 and a first ferromagnetic layer 3. The first ferromagnetic layer 3 is in contact with the wiring layer 2. The first ferromagnetic layer 3 is laminated on, for example, one surface of the wiring layer 2.

The wiring layer 2 includes any one of a metal, an alloy, an intermetallic compound, a metal boride, a metal carbide, a metal silicide, and a metal phosphide, which has a function of generating a spin current by the spin Hall effect when a current flows. The wiring layer 2 may be called a spin-orbit torque wiring.

The wiring layer 2 includes, for example, a non-magnetic heavy metal as a main component. Heavy metals refer to metals with a specific gravity equal to or greater than that of yttrium (Y). Non-magnetic heavy metals are, for example, non-magnetic metals with a large atomic number of 39 or more that have d electrons or f electrons in their outermost shell. The wiring layer 2 is made of, for example, Hf, Ta, or W. Non-magnetic heavy metals have stronger spin-orbit interactions than other metals. The spin Hall effect is caused by the spin-orbit interaction. When spins tend to be unevenly distributed in the wiring layer 2 due to the spin Hall effect, a spin current J_{S} tends to be generated.

The wiring layer 2 may include a magnetic metal. The magnetic metal is a ferromagnetic metal or an antiferromagnetic metal. A small amount of magnetic metal contained in a non-magnetic material acts as a scattering factor for spins. The small amount is, for example, 3% or less of the total molar ratio of the elements constituting the wiring layer. When spins are scattered by a magnetic metal, the spin-orbit interaction is enhanced, and the efficiency of generating a spin current relative to a current is increased.

The wiring layer 2 may include a topological insulator. The topological insulator is a material in which the interior is an insulator or highly resistive material, but a spin-polarized metallic state exists on the surface. The topological insulator has an internal magnetic field due to the spin-orbit interaction. The topological insulator exhibits a new topological phase due to the effect of the spin-orbit interaction even in the absence of an external magnetic field. The topological insulator can generate a pure spin current highly efficiently due to strong spin-orbit coupling and broken inversion symmetry at the edges. Further, since a current flows only on the surface of the topological insulator, a high current density can be achieved with a small amount of current.

Examples of the topological insulator are Sn, SnTe, Bi_{1.5}Sb_{0.5}Te_{1.7}Se_{1.3}, TlBiSe₂, Bi₂Te₃, Bi₁₋ₓSbₓ, (Bi₁₋ₓSbₓ)₂Te₃, and the like. The topological insulator is capable of generating a spin current with high efficiency.

The first ferromagnetic layer 3 is a ferromagnetic material. The ferromagnetic material is, for example, a metal selected from the group consisting of Cr, Mn, Co, Fe, and Ni, an alloy containing one or more of these metals, or an alloy containing these metals and at least one or more of the elements selected from the group consisting of B, C, and N.

The ferromagnetic material is, for example, Co—Fe, Co—Fe—B, Ni—Fe, Co—Ho alloy, Sm—Fe alloy, Fe—Pt alloy, Co—Pt alloy, or CoCrPt alloy. A CoCrPt alloy and an Ll₀ type CoFe alloy have large saturation magnetization and strong magnetic anisotropy, and when these are used for the first ferromagnetic layer 3, the resonant frequency of the spin inductor 10 becomes high.

Further, the first ferromagnetic layer 3 may also be a magnetic insulator. When the first ferromagnetic layer 3 is a magnetic insulator, it is particularly preferable that the wiring layer 2 is a topological insulator. Since the current flows only at the bonding surface between the magnetic insulator and the topological insulator, current loss is reduced, and energy loss due to heat generation and the like can be suppressed.

Further, the first ferromagnetic layer 3 may also be a ferrimagnetic insulator or an antiferromagnetic insulator. When the first ferromagnetic layer 3 is an antiferromagnetic insulator, it is particularly preferable that the wiring layer 1 is a topological insulator. Since the current flows only at the bonding surface between the antiferromagnetic insulator and the topological insulator, current loss is reduced, and energy loss due to heat generation and the like can be suppressed. Furthermore, when the first ferromagnetic layer 3 is an antiferromagnetic insulator, the resonance frequency of the first ferromagnetic layer 3 becomes high and no resonance occurs even in the high frequency region of 10 GHz or more. Therefore, a spin inductor in which the first ferromagnetic layer 3 is an antiferromagnetic insulator can exhibit stable inductance over a wide band. For example, antiferromagnetic insulators include oxides containing magnetic elements such as NiO, MnO, Cr₂O₃, ferrite and garnet, sulfides containing magnetic elements such as MnS, and chlorides containing magnetic elements such as FeCl₂.

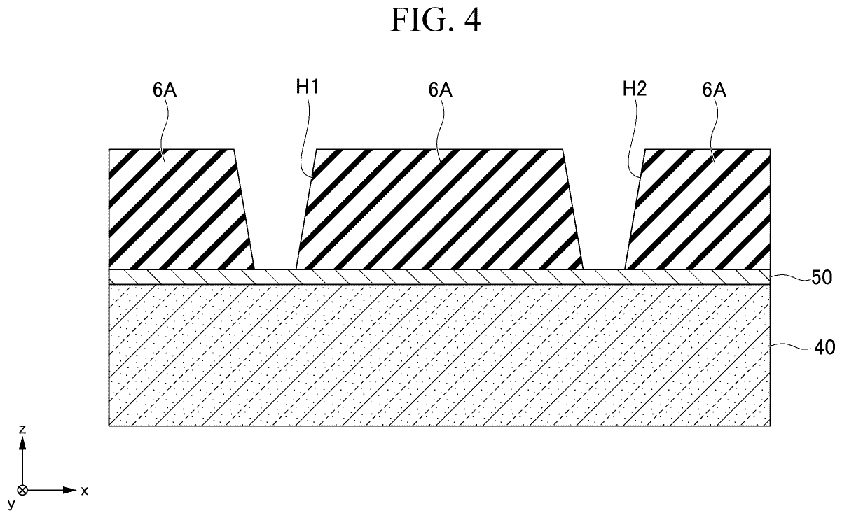

The spin inductor 10 functions as an inductor due to precession of the magnetization of the first ferromagnetic layer 3. FIG. 3 is a schematic view illustrating the function of the spin inductor 10.

The spin inductor 10 functions as an inductor when a current flows along the wiring layer 2. When a current is applied between the first via wiring 4 and the second via wiring 5, the current flows within the plane of the wiring layer 2.

The current flowing through the wiring layer 2 generates a spin current due to the spin Hall effect.

The spin Hall effect is a phenomenon in which a spin current is induced in a direction perpendicular to the direction of the current flowing (for example, the z direction) due to spin-orbit interaction when the current flows. The spin Hall effect is similar to the normal Hall effect in that the moving direction of moving charges (electrons) can be bent. The normal Hall effect is caused when the moving direction of charged particles moving in a magnetic field is bent by the Lorentz force. In contrast, the spin Hall effect allows the direction of spin movement to be bent simply by the movement of electrons (the flow of current) even in the absence of a magnetic field.

For example, when a current flows in the x direction of the wiring layer 2, for example, spins S1 polarized in the −y direction are bent in the +z direction relative to the travel direction, and spins S2 polarized in the +y direction are bent in the −z direction relative to the travel direction. The bending directions of the spins S1 and S2 may be opposite to each other.

The spins S1 are injected into the adjacent first ferromagnetic layer 3. The magnetization M3 of the first ferromagnetic layer 3 precesses due to the spins S1 injected from the wiring layer 2.

When the magnetization M3 of the first ferromagnetic layer 3 precesses, energy conversion occurs between the magnetic moment and the current, and the spin inductor 10 exhibits an inductor function.

From the viewpoint of maintaining the precession of the magnetization M3, the magnetization M3 preferably has a component oriented in the z direction or the x direction, and is more preferably oriented in the z direction in the initial state where neither an external magnetic field nor a current is applied to the spin inductor. When the magnetization M3 is oriented in the y direction, magnetization reversal may occur and the magnetization precession may not be maintained even when no external magnetic field is applied. When the magnetization M3 is oriented in the x direction or the z direction, magnetization reversal is difficult to occur in the absence of the magnetic field. Since the spin inductor device 10 exhibits an inductor function by using energy conversion between a magnetic moment and a current, the inductor function is not fully exhibited when the precession of magnetization stops.

Furthermore, even if the magnetization M3 is oriented in the y direction, it is possible to maintain the precession of the magnetization by adjusting the current density flowing through the wiring layer 2.

Since the spin inductor 10 generates a resonance phenomenon at the frequency of the ferromagnetic resonance of the first ferromagnetic layer 3, it is difficult for the spin inductor device 100 to stably operate as an inductor near the resonance frequency. Therefore, the spin inductor 10 is used at a frequency sufficiently lower or sufficiently higher than the ferromagnetic resonance frequency of the spin inductor 10. The sufficiently low frequency or sufficiently high frequency generally indicates a frequency that is deviated from the ferromagnetic resonance frequency by 5% or more based on ferromagnetic resonance frequency. The spin inductor 10 is capable of generating inductance even at frequencies exceeding, for example, 10 GHz or THz. Furthermore, the inductance generated by the spin inductor 10 functions sufficiently even at 1 nH or less.

Since the spin inductor 10 exhibits an inductor function by using energy conversion between current and magnetic moment, the spin inductor can exhibit large inductance even in a small size. For example, even if the maximum width of the spin inductor 10 when viewed in plan view from the z direction is 0.003 mm or less, an inductance of 0.1 μH or more and 10 μH or less can be achieved. Furthermore, even if the maximum width of the spin inductor 10 is several tens of nm and the length is several hundreds of nm when viewed in plan view from the z direction, the spin inductor 10 exhibits an inductance of several nH to several hundreds of nH. Small inductance elements are particularly in demand in areas where it is difficult to incorporate large elements, such as in space and at cryogenic temperatures.

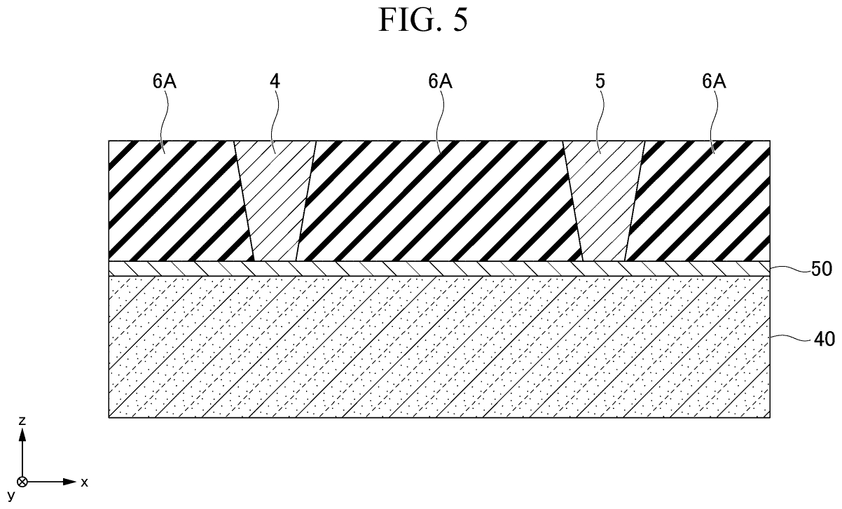

Next, a first example of a method of manufacturing the spin inductor device 100 according to this embodiment will be described. FIGS. 4 to 10 are schematic views illustrating the first example of the method of manufacturing the spin inductor device 100 according to this embodiment.

First, a substrate 40 shown in FIG. 4 is prepared. The substrate 40 is a support for producing the spin inductor 10. The substrate 40 is a component different from the substrate 21. The substrate 40 is made of, for example, Si or AlTiC. The substrate 40 may be a single crystal substrate made of at least one selected from the group consisting of Si, GaAs, Ge, MgO, a material having a spinel structure, and a material having a cubic; perovskite structure. Examples of materials having a spinel structure include MgAl₂O₄, ZnAl₂O₄, and γ-Al₂O₃, and examples of materials having a cubic perovskite structure include SrTiO₃. A single crystal substrate has high lattice matching with the wiring layer 2 and the first ferromagnetic layer 3, and can improve the magnetic properties of the first ferromagnetic layer 3 when using a single crystal substrate for the substrate 40.

A release layer 50 is formed on the substrate 40. The release layer 50 is made of, for example, graphene. Graphene is a sheet-like material with a thickness equivalent to one atomic layer, in which carbon atoms are connected in the in-plane direction by sp bonds, and has excellent cleavage properties. When graphene is laminated on the substrate 40, it becomes easier to release the substrate 40 or the spin inductor 10 from the release layer 50 in a later process.

Further, the release layer 50 may also be hydrogen injected silicon. In this case, the release layer 50 can be produced by injecting hydrogen ions into the substrate 40. Hydrogen ions injected into the substrate 40 with similar energies are aligned at similar height positions on the substrate 40. When the substrate 40 is heated to a temperature of 400 °C to 1000 °C, the substrate 40 is cleaved along the ion-injected portions where the hydrogen ions have been injected.

As shown in FIG. 4, an insulating layer 6A is formed on the release layer 50 and openings H1 and H2 are formed at predetermined positions of the insulating layer 6A. The insulating layer 6A is a part of the above-described insulating layer 6.

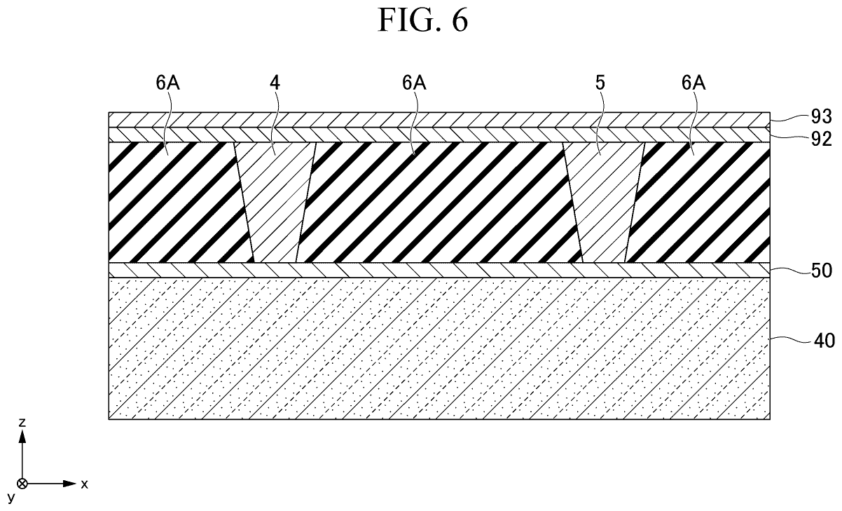

As shown in FIG. 5, the openings H1 and 112 are filled with a conductor. The first via wiring 4 and the second via wiring 5 are formed by filling the openings HI and H2 with a conductor. In this case, the first via wiring 4 and the second via wiring 5 are in contact with the release layer 50.

As shown in FIG. 6, a conductive layer 92 and a ferromagnetic layer 93 are sequentially laminated. The layers can be formed by, for example, sputtering, chemical vapor deposition (CVD), electron beam deposition (EB deposition), atomic laser deposition, or the like.

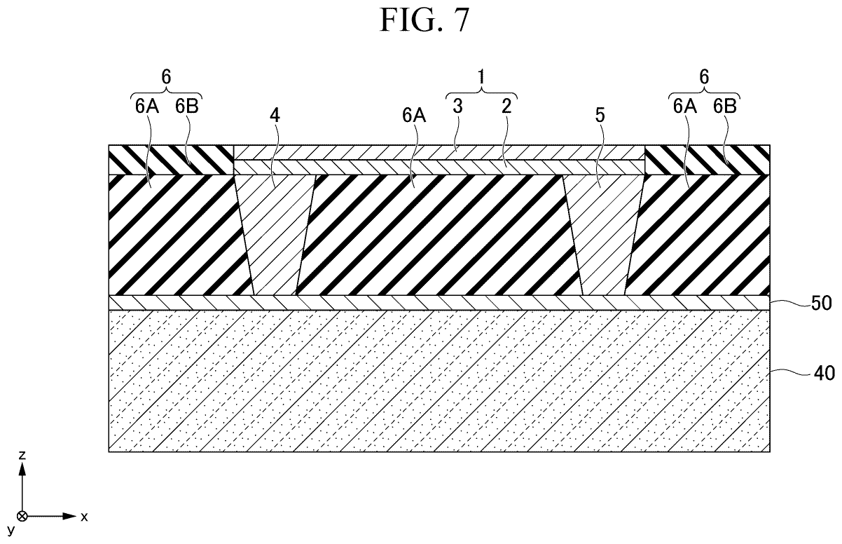

As shown in FIG. 7, the inductor layer 1 including the wiring layer 2 and the first ferromagnetic layer 3 are formed above the release layer 50. Specifically, the conductive layer 92 and the ferromagnetic layer 93 formed in FIG. 6 are processed into a predetermined shape. The processing can be performed, for example, by using photolithography. The conductive layer 92 becomes the wiring layer 2, and the ferromagnetic layer 93 becomes the first ferromagnetic layer 3. Through such a procedure, the spin inductor including the substrate 40, the inductor layer 1, and the release layer 50 can be obtained. The release layer 50 is located between the substrate 40 and the inductor layer 1. Subsequently, the wiring layer 2 and the first ferromagnetic layer 3 are covered with an insulating layer 6B. The insulating layer 6B is a part of the above-described insulating layer 6.

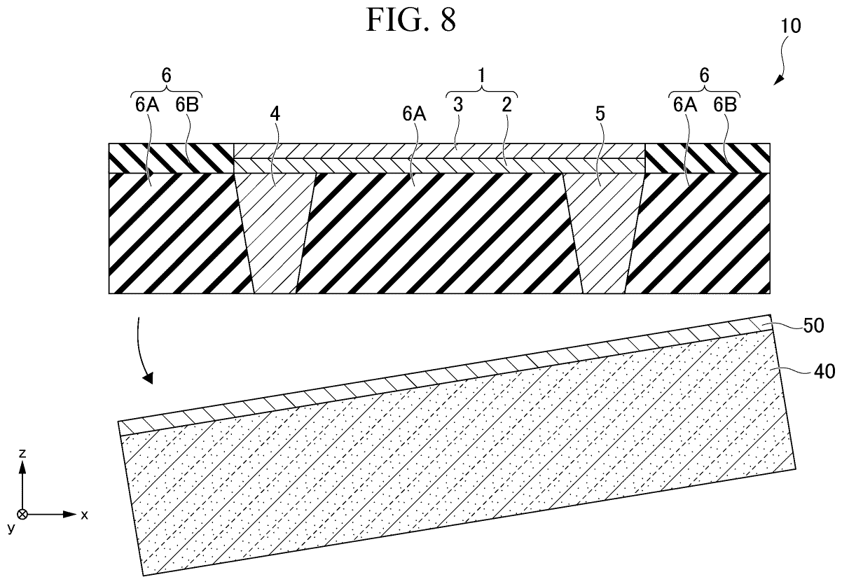

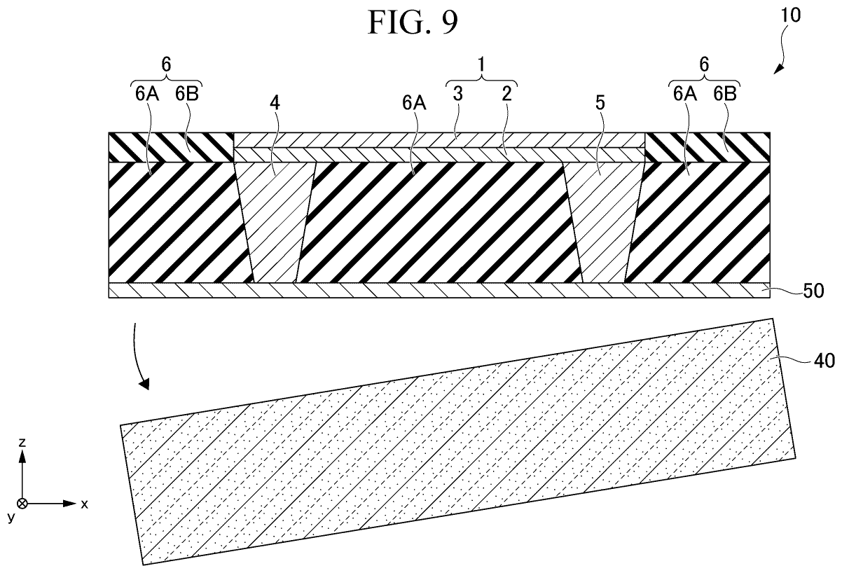

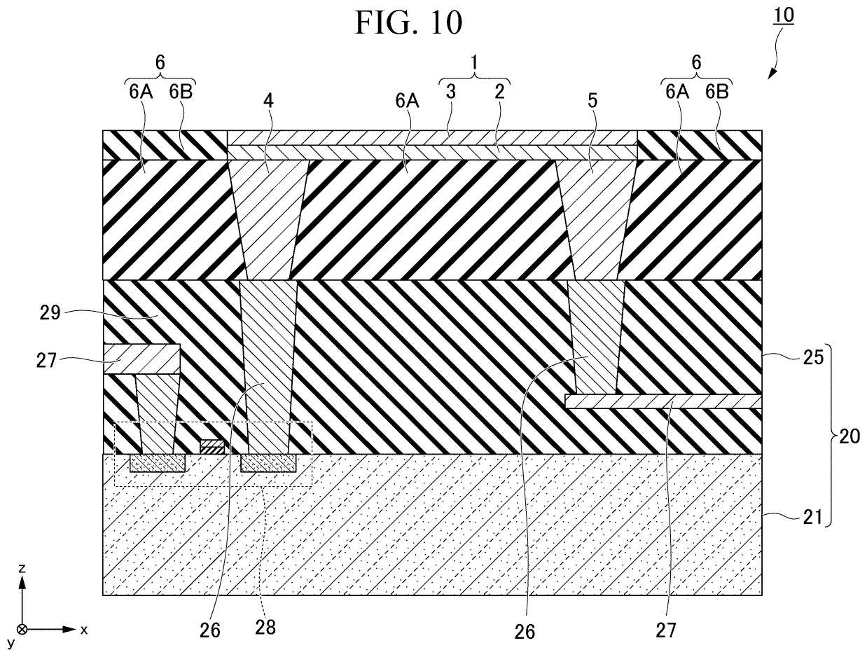

As shown in FIG. 8 or 9, the substrate 40 and the spin inductor 10 including the inductor layer 1 are released through the release layer 50. When the release layer 50 is made of graphene, the release layer 50 is released by applying forces in opposite directions to the substrate 40 and the spin inductor 10. When the release layer 50 is made of silicon containing hydrogen, the release layer 50 is released by heating the substrate 40 and the spin inductor 10.

The release layer 50 may remain on the side of the substrate 40 as shown in FIG. 8 or may remain on the side of the spin inductor 10 as shown in FIG. 9. As shown in FIG. 9, when the release layer 50 remains on the side of the spin inductor 10, the spin inductor including the inductor layer 1 and the release layer 50 can be obtained. An intermediate layer consisting of the first via wiring 4, the second via wiring 5, and the insulating layer 6A is present between the inductor layer 1 and the release layer 50. The release layer 50 remaining on the spin inductor 10 is removed when bonding to the integrated circuit 20.

As shown in FIG. 10, the integrated circuit 20 and the spin inductor 10 are electrically connected. For example, as shown in FIG. 10, one of the plurality of via wirings 26 formed on the integrated circuit 20 is bonded to the first via wiring 4, and one of the plurality of via wirings 26 is bonded to the second via wiring 5. The via wiring 26 and the first via wiring 4, and the via wiring 26 and the second via wiring 5 may be directly connected or may be connected via solder. For example, the first via wiring 4, the second via wiring 5, and the plurality of via wirings 26 may be made of copper (Cu), and after the surfaces of each are planarized, these vias may be directly bonded to each other by Cu—Cu bonding.

The protective layer 30 is formed on one surface of the laminate in which the integrated circuit 20 and the spin inductor 10 are bonded. Through such a procedure, the spin inductor device 100 according to this embodiment can be produced.

In the method of manufacturing the spin inductor device 100 according to the first example, the spin inductor 10 produced on the substrate 40 different from the integrated circuit 20 is later bonded to the integrated circuit 20. Therefore, the high-quality spin inductor 10 can be manufactured regardless of the flatness of the surface of the integrated circuit 20. Furthermore, since the substrate 40 used in producing the spin inductor 10 can be reused, the total cost involved in producing the spin inductor device 100 can be reduced.

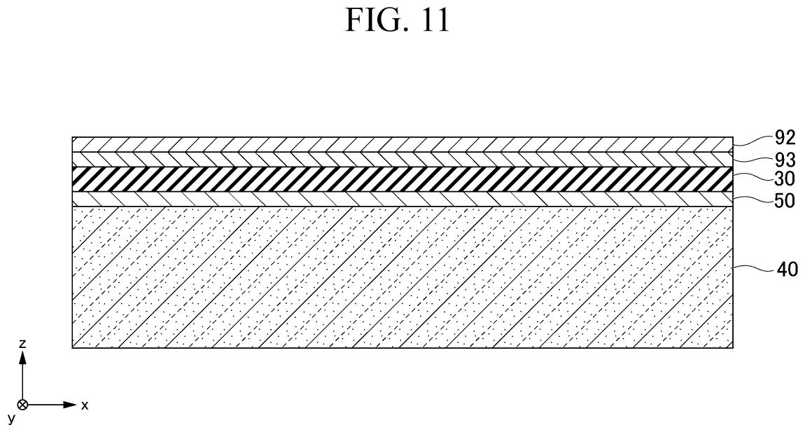

Next, a second example of the method of manufacturing the spin inductor device 100 according to this embodiment will be described. FIGS. 11 to 16 are schematic views illustrating the second example of the method of manufacturing the spin inductor device 100 according to this embodiment.

As shown in FIG. 11, the release layer 50, the protective layer 30, the ferromagnetic layer 93, and the conductive layer 92 are laminated in this order on the substrate 40. The substrate 40, the release layer 50, the protective layer 30, the ferromagnetic layer 93, and the conductive layer 92 are the same as those in the first example.

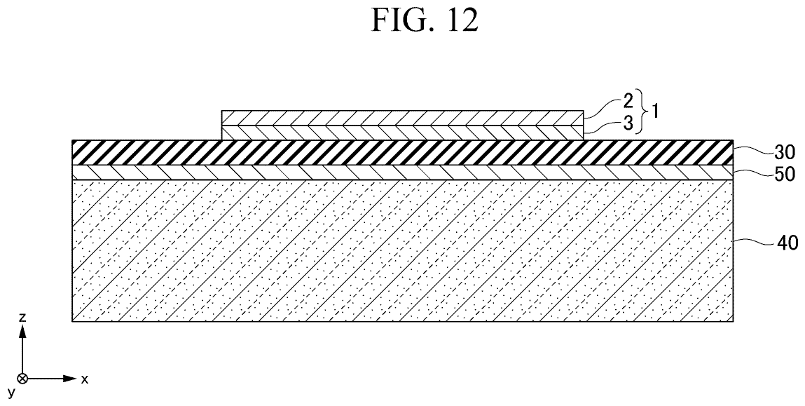

As shown in FIG. 12, the conductive layer 92 and the ferromagnetic layer 93 are processed into a predetermined shape. The processing can be performed, for example, by using photolithography. The conductive layer 92 becomes the wiring layer 2, and the ferromagnetic layer 93 becomes the first ferromagnetic layer 3.

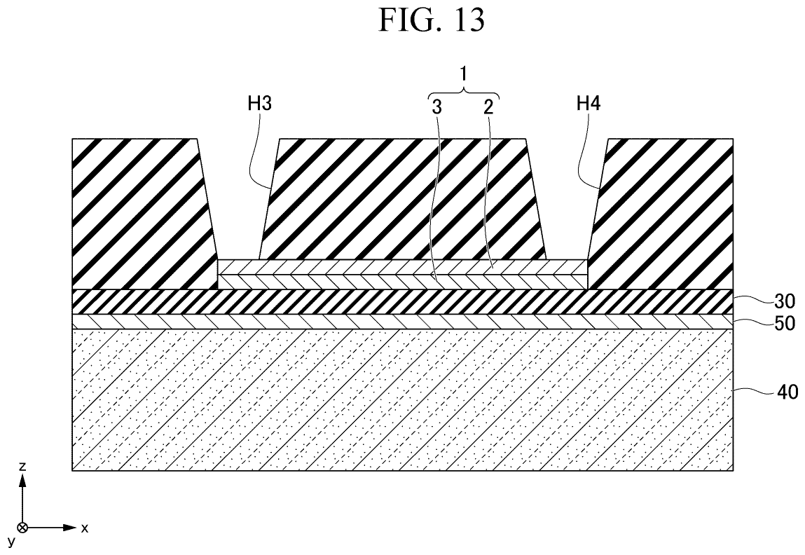

As shown in FIG. 13, the insulating layer 6 is formed to cover the wiring layer 2 and the first ferromagnetic layer 3. Then, openings H3 and H4 are formed at the respective positions overlapping the wiring layer 2 of the insulating layer 6.

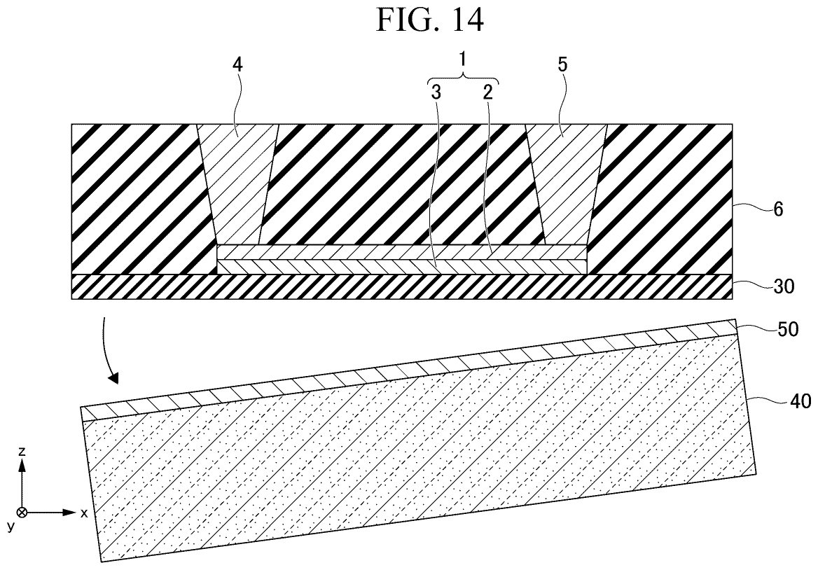

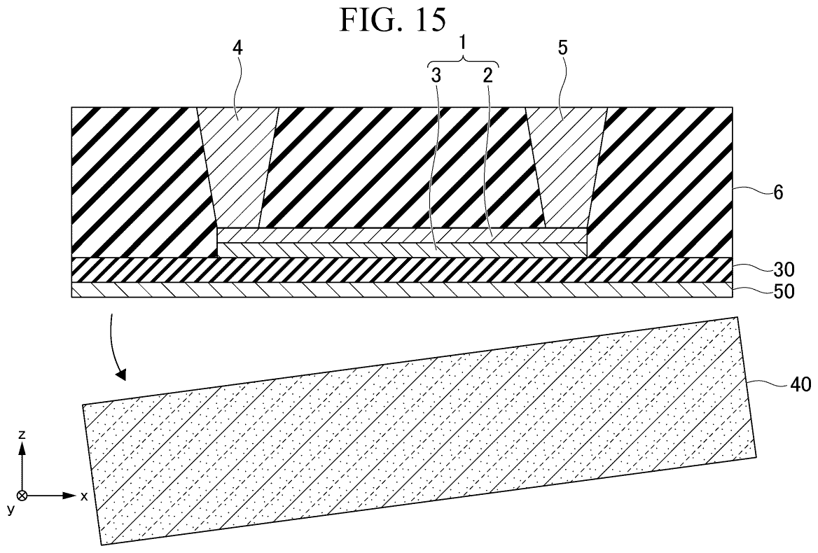

As shown in FIGS. 14 and 15, the opening H3 and the opening H4 are filled with a conductor. The opening H3 becomes the first via wiring 4, and the opening H4 becomes the second via wiring 5. Then, the substrate 40 and the spin inductor 10 are released at the interface between the release layer 50 and the protective layer 30 (FIG. 14) or the interface between the release layer 50 and the substrate 40.

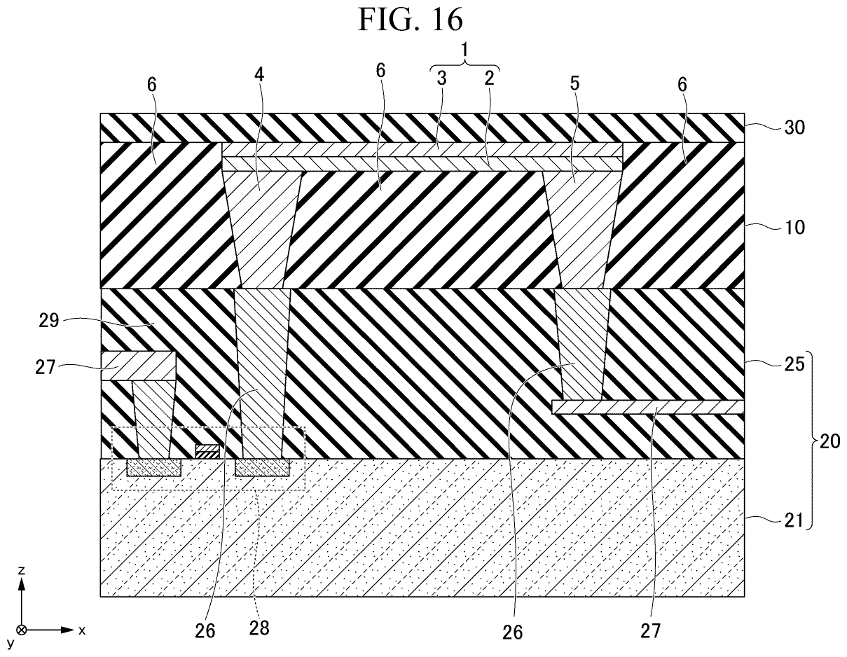

As shown in FIG. 16, the integrated circuit 20 and the spin inductor 10 are electrically connected to each other. At this time, the spin inductor 10 is bonded to the integrated circuit 20 with its top and bottom inverted. For example, as shown in FIG. 16, any one of the plurality of via wirings 26 formed in the integrated circuit 20 is bonded to the first via wiring 4, and any one of the plurality of via wirings 26 is bonded to the second via wiring 5. The via wiring 26 and the first via wiring 4, and the via wiring 26 and the second via wiring 5 may be directly connected (for example, by Cu-Cu bonding) or may be connected via solder.

In the method of manufacturing the spin inductor device 100 according to the second example, the spin inductor 10 produced on the substrate 40 different from the integrated circuit 20 is later bonded to the integrated circuit 20, Therefore, the high-quality spin inductor 10 can be produced at low cost similarly to the manufacturing method according to the first example.

Further, in the manufacturing method according to the second example, since the protective layer 30 is formed when forming the spin inductor 10 on the substrate 40, it is not necessary to form the protective layer 30 after bonding the spin inductor 10 and the integrated circuit 20 to each other.

Further, in the second example, the protective layer 30 is formed between the release layer 50 and the ferromagnetic layer 93, but the ferromagnetic layer 93 may be directly formed on the release layer 50 (see FIG. 11). Specifically, the release layer 50, the ferromagnetic layer 93, and the conductive layer 92 may be laminated in this order on the substrate 40 (a third example of the spin inductor device manufacturing method).

When the release layer 50 is made of graphene, the thickness of the graphene is very thin. The wave functions of the atoms sandwiching the graphene in the laminating direction permeate beyond the graphene to the positions of the atoms on the opposite side. Therefore, graphene has little effect on the crystallinity of the layers sandwiching the graphene (the substrate 40 and the ferromagnetic layer 93 in the third example). Further, the same applies when the release layer 50 is made of hydrogen-injected silicon. In the manufacturing method of the third example, if the substrate 40 is a single crystal substrate, the lattice matching between the single crystal substrate and the ferromagnetic layer 93 is high, so that a high-quality ferromagnetic layer 93 can be obtained. The quality of the ferromagnetic layer 93 is directly related to the magnetic properties of the ferromagnetic layer 93 and has a significant effect on the performance of the spin inductor. That is, in the method of manufacturing the spin inductor device 100 according to the third example, the spin inductor 10 can be produced with higher quality.

Although the preferred embodiments have been described in detail above, the present disclosure is not limited to the specific embodiments, and various modifications and variations are possible within the scope of the gist of the present disclosure described in the claims.

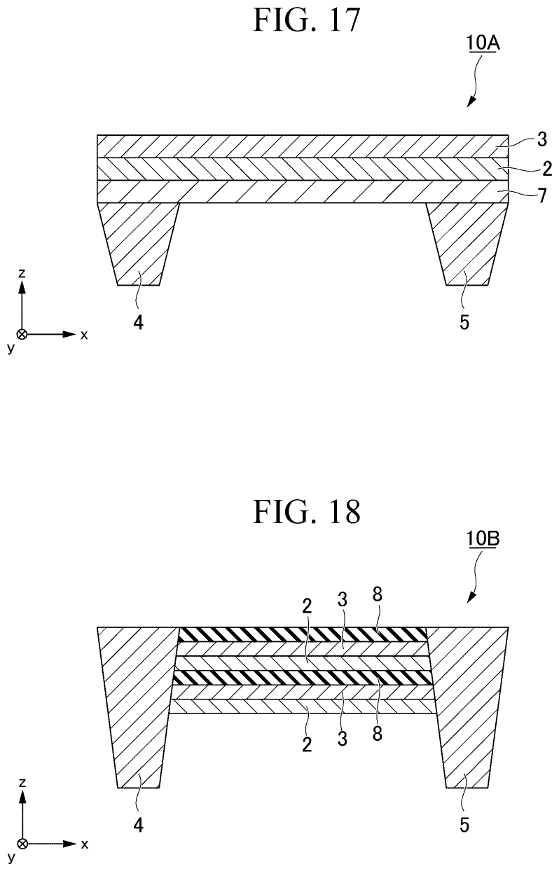

For example, FIG. 17 is a cross-sectional view of a spin inductor 10A according to a first modified example. The spin inductor 10A can be replaced with the spin inductor 10.

The spin inductor 10A includes the wiring layer 2, the first ferromagnetic layer 3, the first via wiring 4, the second via wiring 5, and the second ferromagnetic layer 7. This spin inductor is different from the spin inductor 10 in that the second ferromagnetic layer 7 is provided.

The second ferromagnetic layer 7 is in contact with the wiring layer 2. The second ferromagnetic layer 7 is in contact with a second surface on the opposite side to a first surface in contact with the first ferromagnetic layer 3 in the wiring layer 2.

The second ferromagnetic layer 7 includes a ferromagnetic material. The second ferromagnetic layer 7 may be made of the same material as the first ferromagnetic layer 3. The orientation of the magnetization of the second ferromagnetic layer 7 is oriented in the opposite direction to that of the first ferromagnetic layer 3 in the initial state in which no external magnetic field is applied and no current is applied to the wiring layer 2.

When a current flows through the wiring layer 2, the spins S2 are injected into the second ferromagnetic layer 7 (see FIG. 3). The spins S2 cause the magnetization of the second ferromagnetic layer 7 to precess.

In the spin inductor 10A, the magnetizations of the first ferromagnetic layer 3 and the second ferromagnetic layer 7 precess due to spins injected from the wiring layer 2. Since energy conversion occurs between the magnetic moment of the precessing magnetization and the current, the spin inductor 10A functions as an inductor. Furthermore, since the spin inductor 10A according to this embodiment uses spins generated from both sides of the wiring layer 2, a large inductance is exhibited compared to a case in which spins generated from only one side are used.

Further, for example, FIG. 18 is a cross-sectional view of a spin inductor 10B according to a second modified example. The spin inductor 10B can be replaced with the spin inductor 10.

The spin inductor 10B includes a plurality of units, each of which consists of the wiring layer 2 and the first ferromagnetic layer 3, laminated with a spacer layer 8 interposed therebetween. Although FIG. 8 shows an example in which the unit consisting of the wiring layer 2 and the first ferromagnetic layer 3 has two layers, the layer may be three or more layers.

The spacer layer 8 is located between the first ferromagnetic layer 3 of the first unit and the wiring layer 2 of the second unit. The spacer layer 8 destroys the symmetry of the wiring layer 2 in the z direction. The spacer layer 8 in contact with the first surface of the wiring layer 2 and the first ferromagnetic layer 3 in contact with the second surface are different. For example, the spacer layer 8 and the first ferromagnetic layer 3 are different in any of the crystal structure, composition, and material. If the layers in contact with each surface of the wiring layer 2 are different, the symmetry of the wiring layer 2 in the z direction is destroyed. If the symmetry of the wiring layer 2 is destroyed, the amount of spins injected from the wiring layer 2 to the first ferromagnetic layer 3 increases.

The spacer layer 8 includes a non-magnetic material. The spacer layer 8 may be, for example, a conductor, a semiconductor, or an insulator. When the spacer layer 8 is an insulator, the first via wiring 4 and the second via wiring 5 are caused to penetrate the laminate in order to ensure electrical continuity to each unit.

Since the spin inductor 10B includes a plurality of units each including the wiring layer 2 and the first ferromagnetic layer 3, a larger inductance than a single unit is exhibited. Furthermore, since the spin inductor 10B includes the spacer layer 8 at the unit interface, it is possible to increase the amount of spins injected from the wiring layer 2 into the first ferromagnetic layer 3 and to exhibit a large inductance with a smaller amount of current.

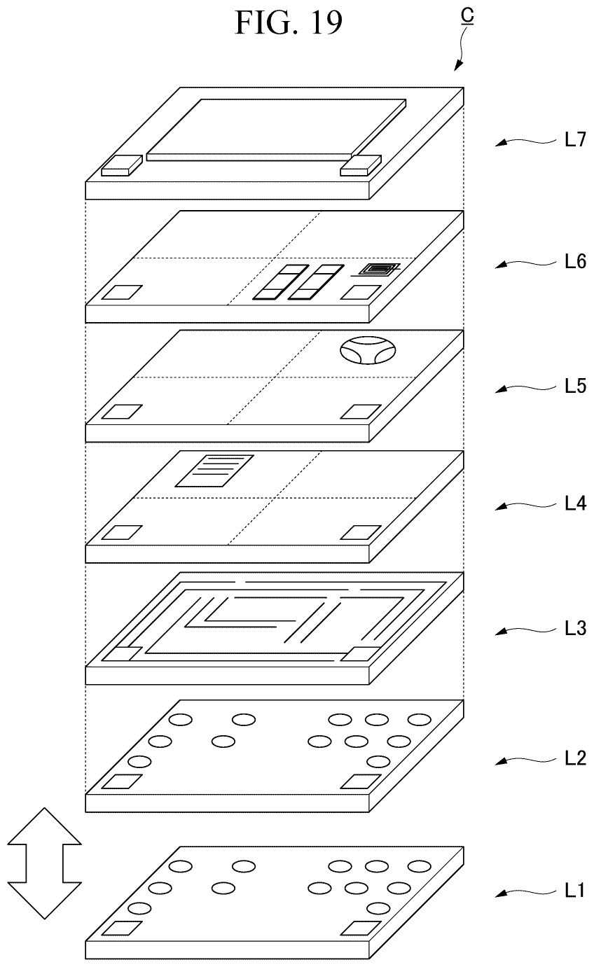

Further, the spin inductor according to the present disclosure can be used by being incorporated into, for example, a module. FIG. 19 shows an application example of the spin inductor according to this embodiment.

In recent years, there has been a study on integrating semiconductor circuits and devices with specific functions, such as memory, into a single chip. The technology of combining semiconductor circuits and devices such as memory on a single chip is called “chiplet” or “heterointegration.”. By integrating these functions into a single chip, latency can be reduced, power consumption can be reduced, and costs can be reduced.

Even with these technologies, passive components need to be separately placed around the chip for the function thereof. Therefore, even if the chips are highly integrated, passive components can be a challenge in miniaturizing the module. By incorporating passive components into chiplets and heterointegration, it is expected that the module can be further miniaturized.

The chip C shown in FIG. 19 includes a semiconductor circuit L1, a connection layer L2, a wiring layer L3, a memory layer LA, a sensor layer L5, an LCR (passive component) layer L6, and an all-solid-state thin-film battery layer L7, which are laminated in this order. Although each layer is bonded to form a single chip, spaces are provided between the layers to facilitate understanding in FIG. 19. The spin inductor according to the present disclosure is formed, for example, in the LCR layer L6. The LCR layer L6 may form not only passive components such as inductance, capacitance, and resistance, which are conventional electronic components, but also spin inductors and spin variable capacitances. The LCR layer L6 is connected to other layers by contact vias, and the entire chip C is used as one module. The spin inductor according to the present disclosure can be applied to a device that has a sensor and a power source as shown in FIG. 19 and can autonomously collect information.

### REFERENCE SIGNS LIST

1 Inductor layer
2 Wiring layer
3 First ferromagnetic layer
4 First via wiring
5 Second via wiring
6, 6A, 6B, 29 Insulating layer
7 Second ferromagnetic layer
8 Spacer layer
10, 10A, 10B Spin inductor
20 Integrated circuit
21, 40 Substrate
25 Circuit layer
26 Via wiring
27 In-plane wiring
28 Electronic component
30 Protective layer
50 Release layer
92 Conductive layer
93 Ferromagnetic layer
100 Spin inductor device

1. A spin inductor comprising:
a substrate;
an inductor layer which includes a wiring layer and a first ferromagnetic layer in contact with the wiring layer; and
a release layer which is located between the substrate and the inductor layer.

2. The spin inductor according to claim 1, further comprising:
a first via wiring and a second via wiring,
wherein each of the first via wiring and the second via wiring connected to the inductor layer.

3. The spin inductor according to claim 2,
wherein the release layer is in contact with the first via wiring and the second via wiring.

4. The spin inductor according to claim 2,
wherein the inductor layer is located between the first via wiring and the second via wiring and the release layer.

5. The spin inductor according to claim 1, further comprising:
a first insulating layer,
wherein the first insulating layer is located between the inductor layer and the release layer.

6. The spin inductor according to claim 1,
wherein the release layer is made of graphene.

7. The spin inductor according to claim 1,
wherein the release layer is made of hydrogen injected silicon.

8. A spin inductor comprising:
an inductor layer which includes a wiring layer and a first ferromagnetic layer in contact with the wiring layer; and
a release layer which is in contact with a first surface of the inductor layer or in contact with the first surface of the inductor layer with an intermediate layer interposed therebetween.

9. A manufacturing method of spin inductor device comprising:
forming a release layer on a substrate;
forming an inductor layer including a wiring layer and a first ferromagnetic layer in contact with the wiring layer on or above the release layer; and
releasing the substrate and the inductor layer through the release layer.

10. The manufacturing method of spin inductor device according to claim 9, further comprising:
electrically connecting the inductor layer released from the substrate to the integrated circuit.

11. The manufacturing method of spin inductor device according to claim 10, further comprising:
connecting first via wiring and second via wiring to the inductor layer,
wherein any one of the plurality of via wirings formed on the integrated circuit is bonded to the first via wiring, and any one of the plurality of via wirings is bonded to the second via wiring.

12. The spin inductor device manufacturing method according to claim 11,
wherein any one of the plurality of via wirings is bonded to the first via wiring by solder, and
wherein any one of the plurality of via wirings is bonded to the second via wiring by solder.
